(19) United States
(12) Patent Application Publication
(10) Pub. No.: US 2001/0035077 A1
(43) Pub. Date: Nov. 1, 2001

(54) Hand tool for removing a lawn mower blade

(76) Inventor: Gary L. Adams, Orlando, FL (US)

Correspondence Address: William M. Hobby, III, 157 E. New England Avenue, #375, Winter Park, FL, 32789, US

(21) Appl. No.: 09/818,159

(22) Filed: Mar. 27, 2001

Related U.S. Application Data
(60) Provisional application No. 60/192,792, filed on Mar. 28, 2000.

(51) Int. Cl. B25B 13/58

(52) U.S. Cl. 81/180.1

(57) ABSTRACT

A tool apparatus for removing a lawn mower blade comprises an elongated arm having a handle on one end thereof and a socket wrench removably attached to the other end thereof. A blade holding yoke is removably attached to the other end of the elongated arm and has a pair of spaced yoke arms having a space therebetween. A blade holding yoke can be positioned under a blade holding nut for wedging between the blade and the blade holding nut while the wrench is engaged with the blade holding nut. The blade is held by the blade holding yoke while the wrench is rotated to remove the blade holding nut and blade from the lawn mower.

### BACKGROUND OF THE INVENTION

A hand tool for removing a lawn mower blade for sharpening or replacing of the blade of a rotary lawn mower and prevents rotation of the blade while removing the lawn mower blade removal nut holding the blade to the blade shaft.

For peak efficiency, lawn mower blades should be resharpened or replaced regularly. Removing a blade retaining nut, which has been overtightened or rusted in place, can be difficult and even dangerous. It is necessary to lock the blade in place against rotation so that the high torque necessary to loosen the nut, can be applied with a long wrench. In the past, it has been common to use a block of wood or a brick or other handy object to place between the blade and the discharge chute of a rotary lawn mower. This has worked satisfactory at times but the haphazard nature of the holding object can result in the holding block slipping and the blade rotating to cut or bruise a person's hand while in the process of changing the blade. It has also been common to use a heavy glove but this frequently does not provide sufficient leverage during loosening of the nut. The problem is made more difficult because the rotary lawn mower blade is supported below a cowling and typically has an engine mounted on top of the cowling making access to the blade difficult. Access is typically obtained by placing the lawn mower on blocks or on elevated jacks or tilting the lawn mower to one side for access to the blade. This places the lawn mower in an awkward position for properly holding the blade in place while removing the retaining nut with a socket wrench. Access is even more difficult with heavy riding mowers which cannot be easily tilted or raised for access to the blade.

In the past, there have been a variety of patents dealing with tools for holding a rotatable lawn mower blade, such as shown in the Davidson U.S. Pat. No. 4,956,905 for a tool for holding a rotatable lawn mower blade which has a U-shaped bracket on the end of an elongated handle for placing over the blade and in the U.S. Pat. No. 4,882,960 to Kugler for a lawn mower blade lock which locks the blade to the side of the cowling in a manner that the blade holder can also be used to lift and tilt a small lawn mower. The Taylor U.S. Pat. No. 4,564,991 is a tool for holding a blade for installation and removal thereof. Other tools for working on lawn mower blades can be seen in the U.S. Pat. No. 4,736,544, to Greenquist, for a blade holder for sharpening lawn mower blades in which the blade is sharpened while still attached to the mower and in the Wanie U.S. Pat. No. 5,865,018 for a cutter blade removal tool which slips onto the end of the blade and protrudes into the discharge chute of the cowling.

The present invention is an improvement to the prior lawn mower blade removal tools and simplifies and improves the holding of the blade and the removal of a rotary lawn mower blade holding nut from a rotary blade lawn mower.

### SUMMARY OF THE INVENTION

A tool apparatus for removing a lawn mower blade comprises an elongated arm having a handle on one end thereof and a socket wrench removably attached to the other end thereof. A blade holding yoke is removably attached to the other end of the elongated arm and has a pair of spaced yoke arms having a space therebetween. A blade holding yoke can be positioned under a blade holding nut for wedging between the blade and the blade holding nut while the wrench is engaged with the blade holding nut. The blade is held by the blade holding yoke while the wrench is rotated to remove the blade holding nut and blade from the lawn mower.

### BRIEF DESCRIPTION OF THE DRAWINGS

Other objects, features, and advantages of the present invention will be apparent from the written description and the drawings in which:

FIG. 1 is a perspective view of a lawn mower blade removal tool in accordance with the present invention;

FIG. 2 is a partial perspective view of the lawn mower tool of FIG. 1;

FIG. 3 is a partial exploded perspective view of the lawn mower tool of FIGS. 1 and 2;

FIG. 4 is a side elevation of the lawn mower tool nut removal portion;

FIG. 4A is a sectional view of a lawn mower having the lawn mower tool nut removal portion thereon;

FIG. 5 is a sectional view of a lawn mower having the lawn tool being attached thereto;

FIG. 6 is a sectional view of a lawn mower having the tool of FIGS. 1-3 attached thereto;

FIG. 7 is a perspective view of the lawn mower tool of FIGS. 1 through 3 attached to a lawn mower blade; and

FIG. 8 is a perspective view of the lawn mower tool of FIG. 7 illustrating removal of the tool from the lawn mower blade.

### DESCRIPTION OF THE PREFERRED EMBODIMENT

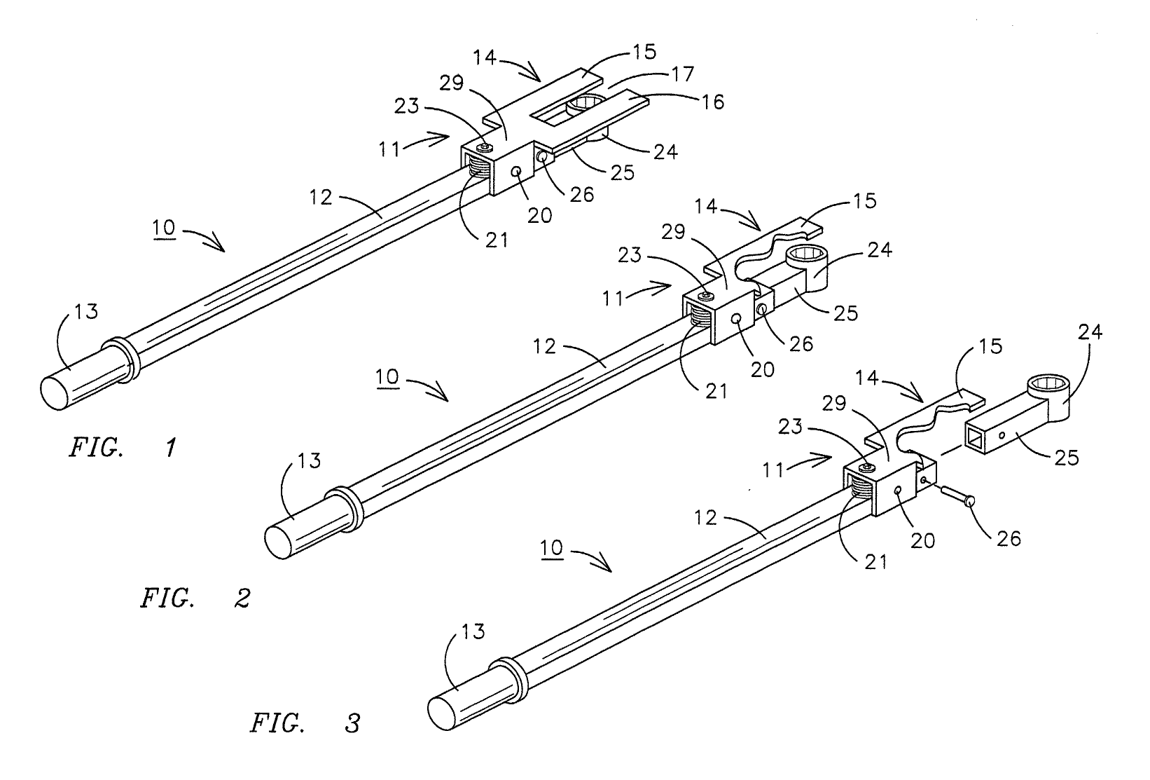

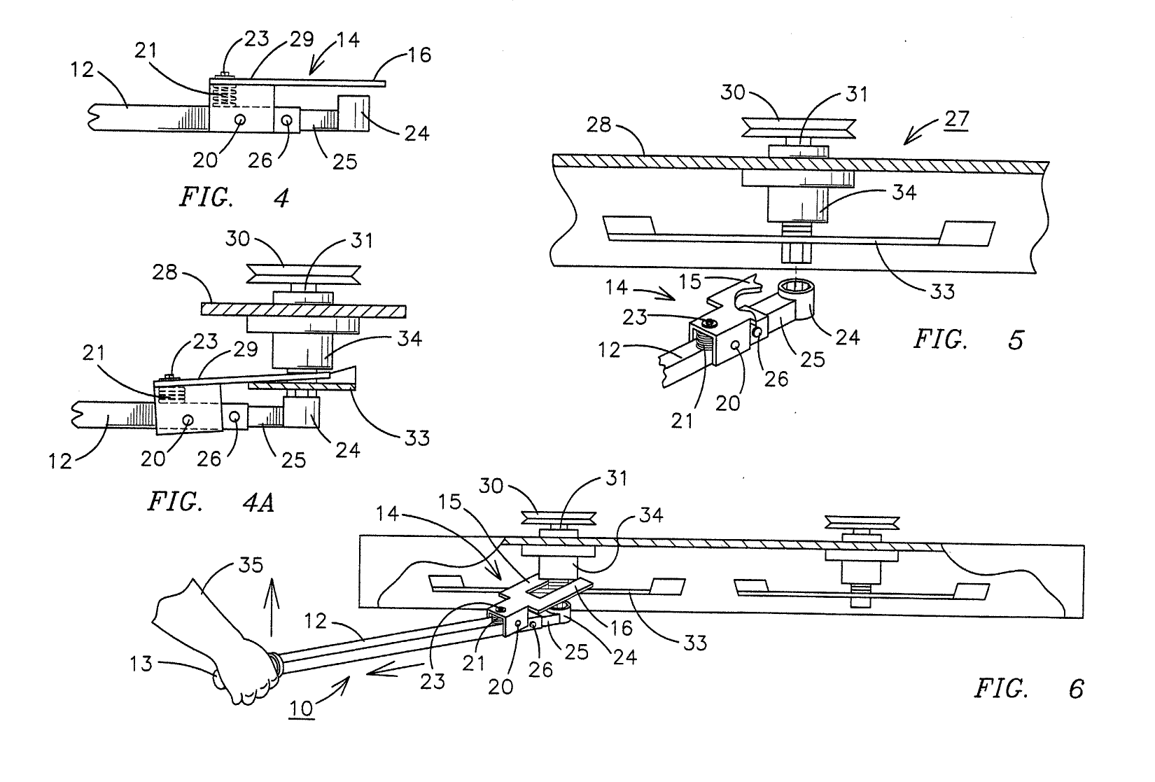

Referring to the drawings, FIGS. 1 through 3, a lawn mower blade removal tool 10 has a blade attaching and removing portion 11 having an elongated arm 12 having a handle 13 on the end thereof. The blade removal portion 11 has a blade holding yoke 14 having a pair of yoke arms 15 and 16 divided by a space 17. The yoke 14 has perpendicular extending side members 18 attached with a hinge pin 20 to the arm 12 in a manner that the yoke 14 can swing on the pin 20. A coil spring 21 is mounted beneath the rear surface 22 of the yoke 14 and is held in place with a pin 23. Thus, the yoke 14 can move on the pin 20 against the spring 21 which biases the yoke into the position as shown in FIG. 1. A socket wrench socket 24 is attached to a supporting arm 25 and telescopes within the arm 12 where it is locked in place with a pin 26. Removal of the pin 26 allows the arm 25 and the socket 24 to be removed from the attachment to the arm 12 and replaced with a different size socket 24 if desired.

The operation of the lawn removal tool can be seen in connection with FIGS. 4A, 5, 6, 7 and 8 in which a portion of a lawn mower 27 has a cowling 28 and a pulley 30 connected to a shaft 31. The shaft 31 passes through the cowling 28 and has the blade attached thereto with a blade holding nut or bolt 32. It will be understood that an engine mounted to the cowling will have a belt connected to the pulley 30 to rotate the rotary lawn mower blade 33. A journal portion 34 is attached to the bottom of the cowling 28 for supporting the rotary shaft 31 therein. In operation, the blade removing tool 10 held by a person's arm 35 gripping the handle 13 slides the yoke 14 over the blade 33 and beneath the journal portion 34. By lifting the yoke against the spring 21 on the pin 20, the socket 24 can be placed on the removal nut 32. Pressing on the handle 12 by the operators 35 can force the yoke 14 to lock against the blade while rotating the handle 12 to loosen the nut 32 with the socket 24 while removing the nut 32 and the blade 33. The handle 12 is raised to compress the spring 21 supporting the yoke 14 to remove the socket 24 from the nut 32 so that the yoke 14 can be slid from between the blade and the journal 34 to remove the lawn mower blade removal tool 10.

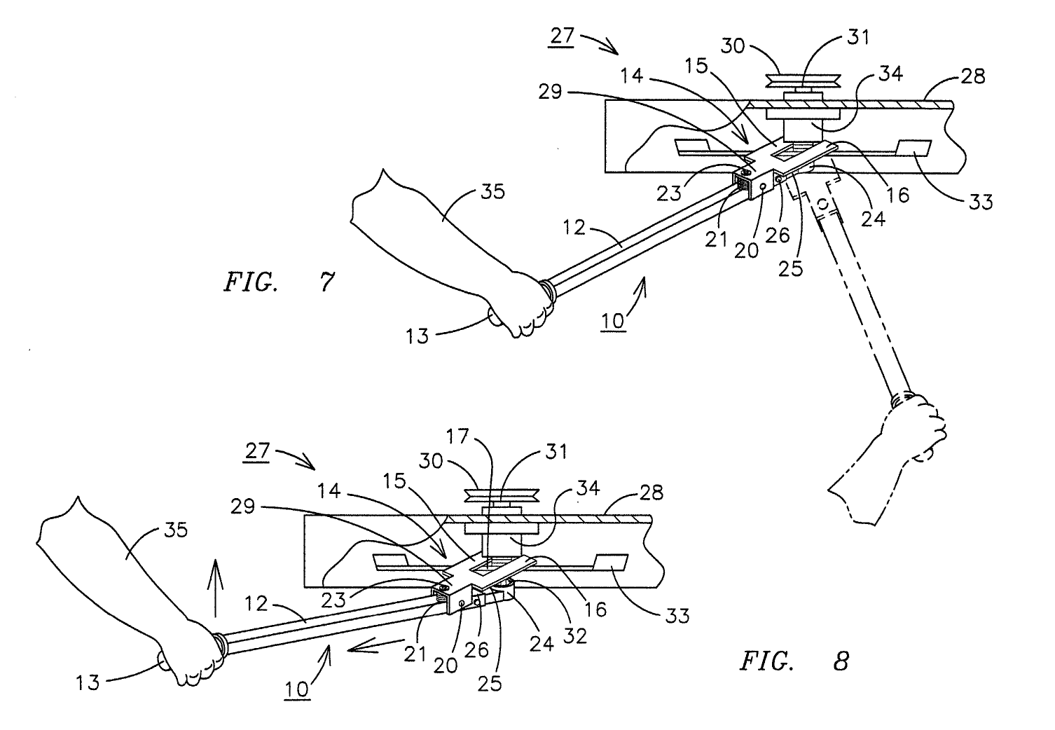

It should be clear at this time that a lawn mower blade removal tool for a rotary lawn mower has been provided and especially for a commercial type lawn mower, such as seen in FIG. 6 having two lawn mower blades, and which advantageously holds the blade while loosening the attachment nut for the blade from the supporting shaft. However, it should be clear that the present invention is not to be construed as limited to the forms shown which are to be considered illustrative rather than restrictive.

I claim:

1. A tool for removing a lawn mower blade comprising:
an elongated arm having a handle on one end thereof;
a wrench movably attached to the other end of said elongated arm;
a blade holding yoke movably attached to the other end of said elongated arm, said blade holding yoke having a pair of spaced yoke arms having a space therebetween and positioned to fit under a blade holding nut for wedging between said blade and blade holding nut while said wrench is engaged with said blade holding nut whereby said blade is held by said blade holding yoke while said wrench is rotated to remove said blade holding nut and blade from said lawn mower.

2. A tool for removing a lawn mower blade in accordance with claim 1 in which said wrench is hinged to the other end of said elongated arm.

3. A tool for removing a lawn mower blade in accordance with claim 2 in which said blade holding yoke is hinged to the other end of said elongated arm.

4. A tool for removing a lawn mower blade in accordance with claim 3 in which said blade holding yoke has a channel end is hinged with a hinge pin to the other end of said elongated arm.

5. A tool for removing a lawn mower blade in accordance with claim 4 in which said wrench is hinged with a hinge pin to the other end of said elongated arm.

6. A tool for removing a lawn mower blade in accordance with claim 5 in which said wrench is a socket wrench having a socket sized for a blade holding nut.

7. A tool for removing a lawn mower blade in accordance with claim 5 in which said elongated arm and wrench are made of steel.
